(19) United States
(12) Patent Application Publication
(10) Pub. No.: US 2018/0103471 A1
(43) Pub. Date: Apr. 12, 2018

(54) SPLIT DWELL TIME SCAN OPTIMIZATION FOR DELAY SENSITIVE TRAFFIC

(71) Applicant: QUALCOMM Incorporated, San Diego, CA (US)

(72) Inventors: Yash KHARIA, San Diego, CA (US); Viral MODI, San Jose, CA (US); Xuanning GAO, San Diego, CA (US); Sheikh HAFIZ, San Diego, CA (US)

(21) Appl. No.: 15/289,717

(22) Filed: Oct. 10, 2016

(51) Int. Cl. H04W 72/04; H04W 40/24; H04L 29/06; H04L 12/26; H04W 72/10

(52) U.S. Cl. CPC H04W 72/0453; H04W 40/244; H04W 72/10; H04L 43/087; H04L 69/28

(57) ABSTRACT

A method, an apparatus, and a computer-readable medium for wireless communication are provided. In one aspect, an apparatus may be configured to determine a maximum scan time for passive scan of off line channels. The apparatus may be configured to passively scan at least one off line channel. The at least one off line channel may include a DFS channel. The passive scan may include a plurality of contiguous scans spaced apart in time. Each of the plurality of contiguous scans may not exceed the maximum scan time. The apparatus may be configured to receive a plurality of packets interspersed with the plurality of contiguous scans.

### BACKGROUND

### Field

The present disclosure relates generally to communication systems, and more particularly, to dynamic frequency selection (DFS).

### Background

In many telecommunication systems, communications networks are used to exchange messages among several interacting spatially-separated devices. Networks may be classified according to geographic scope, which could be, for example, a metropolitan area, a local area, or a personal area. Such networks may be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks may be preferred when the network elements are mobile and may have dynamic connectivity needs, or if the network architecture is formed in an ad hoc, rather than fixed, topology. Wireless networks may employ intangible physical media in an unguided propagation mode using electromagnetic waves in the radio, microwave, infrared, optical, etc., frequency bands. Wireless networks may facilitate user mobility and rapid field deployment when compared to fixed wired networks.

In DFS, wireless clients may first passively/silently scan DFS channels to detect whether or not beacons are detected on that particular channel in order to identify an access point (AP). Once a beacon is detected, the client device may actively scan on that channel. In an active scan, the client device may send out probe requests on the channel. The AP on the channel may respond with probe responses to enable the client device to determine the presence of an AP on the channel. In a passive scan, the client device may not transmit any form of energy (e.g., signals) on the channel. The client device may remain silent (e.g., abstaining from transmitting on the channel) and listen to the channel in order to identify an AP. An AP may transmit a beacon at a particular beacon transmission interval (e.g., Target Beacon Transmission Time (TBTT)). In order to identify an AP, the client device may remain silent and listen continuously to the channel for a time period (referred to as passive scan dwell time) that is at least as long as the beacon transmission interval. The client device may determine that there is an AP on the channel by detecting a beacon on the channel during the dwell time.

The beacon transmission interval (e.g., TBTT) may be the duration of time interval between two consecutive beacons transmitted by an AP. The beacon transmission interval may be long, e.g., 102 ms. Because the passive scan dwell time may need to be at least as long as the beacon transmission interval, the passive scan dwell time may be long as well, e.g., 110 ms. For delay sensitive traffic (e.g., voice and/or video), a long passive scan dwell time may prevent the client device from receiving packets during that period, which may adversely impact user experience. Additionally, there may be many channels to passively scan, which may further compound the degraded user experience caused by the long passive scan dwell time.

### SUMMARY

The following presents a simplified summary of one or more aspects in order to provide a basic understanding of such aspects. The summary is not an exhaustive overview of all contemplated aspects, and is intended to neither identify key or critical elements of all aspects nor delineate the scope of any or all aspects. The sole purpose of the summary is to present some concepts of one or more aspects in a simplified form as a prelude to the more detailed description that is presented later.

In an aspect of the disclosure, a method, a computer-readable medium, and an apparatus (e.g., a station) for wireless communication are provided. The apparatus may be configured to determine a maximum scan time for passive scan of off line channels. The apparatus may be configured to passively scan at least one off line channel. The at least one off line channel may include a DFS channel. The passive scan may include a plurality of contiguous scans spaced apart in time. Each of the plurality of contiguous scans may be based on the maximum scan time. The apparatus may be configured to receive a plurality of packets interspersed with the plurality of contiguous scans.

### BRIEF DESCRIPTION OF THE DRAWINGS

FIG. 1 shows an example wireless communication system in which aspects of the present disclosure may be employed.

FIG. 2 is an exemplary wireless communication system in which passive scan dwell time on a single channel may be split to reduce the impact of off channel scanning on receiving data packets associated with delay sensitive traffic (e.g., voice or video traffic).

FIG. 3A is a diagram illustrating an example of receiving delay sensitive traffic at a fixed interval.

FIG. 3B is a diagram illustrating an example of delay sensitive traffic being impacted by passive scan of DFS channels.

FIG. 3C is a diagram illustrating an example of splitting passive scan dwell time to reduce the impact of off channel scanning on delay sensitive traffic.

FIG. 4 shows an exemplary lookup table that may be used to obtain mini scan durations based on traffic type, de jitter buffer size, and scan priority.

FIG. 5 shows an example functional block diagram of a wireless device that may split passive scan dwell time within the wireless communication system of FIG. 1.

FIG. 6 is a flowchart of an exemplary method for splitting passive scan dwell time into a plurality of mini scans to reduce the impact of off channel scanning on delay sensitive traffic.

FIG. 7 is a functional block diagram of an example wireless communication device that may split passive scan dwell time to reduce the impact of off channel scanning on delay sensitive traffic.

### DETAILED DESCRIPTION

Various aspects of systems, apparatuses, computer-readable medium, and methods are described more fully hereinafter with reference to the accompanying drawings. The disclosure may, however, be embodied in many different forms and should not be construed as limited to any specific structure or function presented throughout the disclosure. Rather, the various aspects are provided so that the disclosure will be thorough and complete, and will fully convey the scope of the disclosure to those skilled in the art. Based on the teachings herein one skilled in the art should appreciate that the scope of the disclosure is intended to cover any aspect of the systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method, which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of the particular aspects fall within the scope of the disclosure. Although some benefits and advantages of aspects may be mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of aspects of the disclosure. The detailed description and drawings are merely illustrative of the disclosure rather than limiting, the scope of the disclosure being defined by the appended claims and equivalents thereof.

Wireless network technologies may include various types of WLANs. A WLAN may be used to interconnect nearby devices together, employing networking protocols. The various aspects described herein may apply to various communication standards, e.g., a wireless protocol standard.

In some aspects, wireless signals may be transmitted according to an IEEE 802.11 protocol using orthogonal frequency-division multiplexing (OFDM), direct-sequence spread spectrum (DSSS) communications, a combination of OFDM and DSSS communications, or other schemes. Implementations of the IEEE 802.11 protocol may be used for sensors, metering, and smart grid networks. In an aspect, certain devices implementing the IEEE 802.11 protocol may consume less power than devices implementing other wireless protocols, and/or may be used to transmit wireless signals across a relatively long range, for example about one kilometer or longer.

In some implementations, a WLAN includes various devices, e.g., the components that access the wireless network. For example, there may be two types of devices: access points (APs) and clients (also referred to as stations or “STAs”). An AP may serve as a hub or base station for the WLAN and a STA may serve as a user of the WLAN. For example, a STA may be a laptop computer, a personal digital assistant (PDA), a mobile phone, etc. In an example, a STA may connect to an AP via a Wi-Fi™ (e.g., an IEEE 802.11 protocol) compliant wireless link to obtain connectivity to the Internet or to other wide area networks. In some implementations, a STA may also be used as an AP.

An access point may also include, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also include, be implemented as, or known as an access terminal (AT), a subscriber station, a subscriber unit, a mobile station, a remote station, a remote terminal, a user terminal, a user agent, a user device, a user equipment, or some other terminology. In some implementations, a station may include a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, the two apparatuses may be directly associated or intermediate apparatuses may be present. For purposes of brevity, the process for establishing an association between two apparatuses will be described using a handshake protocol that employs an “association request” by one of the apparatus followed by an “association response” by the other apparatus. In some aspects, the handshake protocol may require other signaling, such as by way of example, signaling to provide authentication.

Any reference to an element herein using a designation such as “first,” “second,” and so forth does not limit the quantity or order of such elements. Rather, such designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the IEEE 802.11 standard, for example. Such devices, whether used as a STA or AP or other device, may be used for smart metering or in a smart grid network. Such devices may provide sensor applications or be used in home automation. The devices may instead of or in addition to be used in a healthcare context, for example for personal healthcare. The devices may also be used for surveillance, to enable extended-range Internet connectivity (e.g. for use with hotspots), or to implement machine-to-machine communications.

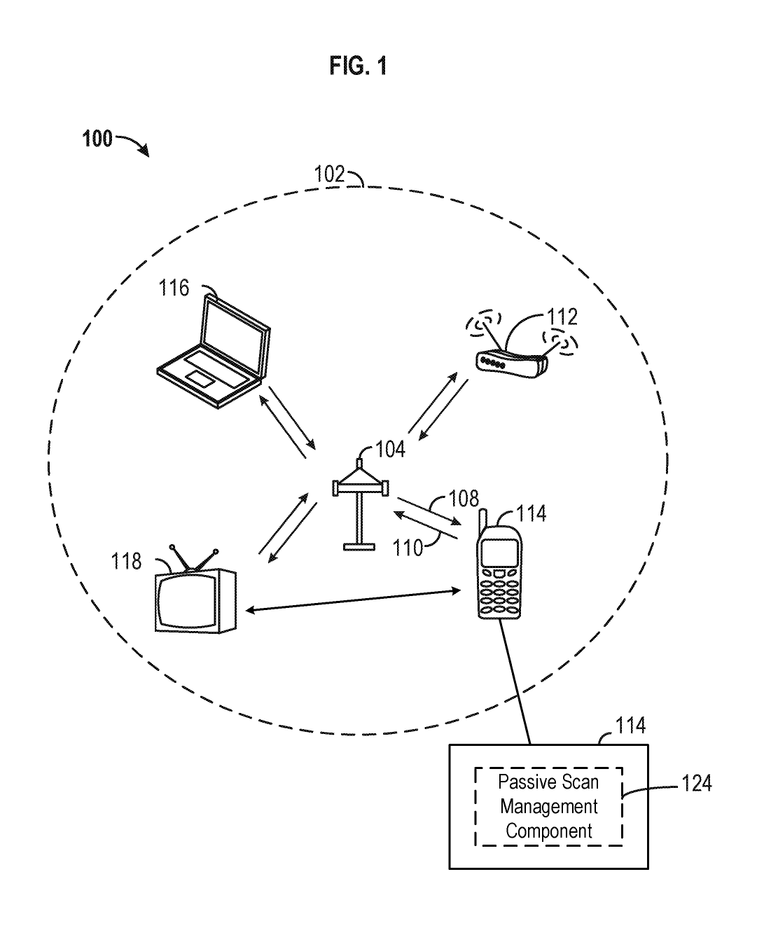

FIG. 1 shows an example wireless communication system 100 in which aspects of the present disclosure may be employed. The wireless communication system 100 may operate pursuant to a wireless standard, for example the IEEE 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques, in which case, the wireless communication system 100 may be referred to as an OFDM/OFDMA system. Alternatively, signals may be sent and received between the AP 104 and the STAs in accordance with CDMA techniques, in which case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously/concurrently without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and may provide wireless communication coverage for a basic service area (BSA) 102. A BSA (e.g., the BSA 102) may be the coverage area of an AP (e.g., the AP 104). The AP 104 along with the STAs associated with the AP 104 and that use the AP 104 for communication may be referred to as a basic service set (BSS). In an aspect, the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit a beacon signal (or simply a “beacon”) on one or more channels (e.g., multiple narrowband channels, each channel including a frequency bandwidth) via a communication link such as the downlink 108, to other nodes (STAs) of the wireless communication system 100, which may help the other nodes (STAs) synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may associate with the AP 104 in order to send communications to and/or to receive communications from the AP 104. In one aspect, information for associating may be included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, either from the beacon or from probe response frames, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the STA 114 may include one or more components for performing various functions. For example, the STA 114 may include a passive scan management component 124. The passive scan management component 124 may be configured to passively scan at least one off line channel. The passive scan may include a plurality of contiguous scans spaced apart in time. The passive scan management component 124 may be configured to receive a plurality of packets interspersed with the plurality of contiguous scans.

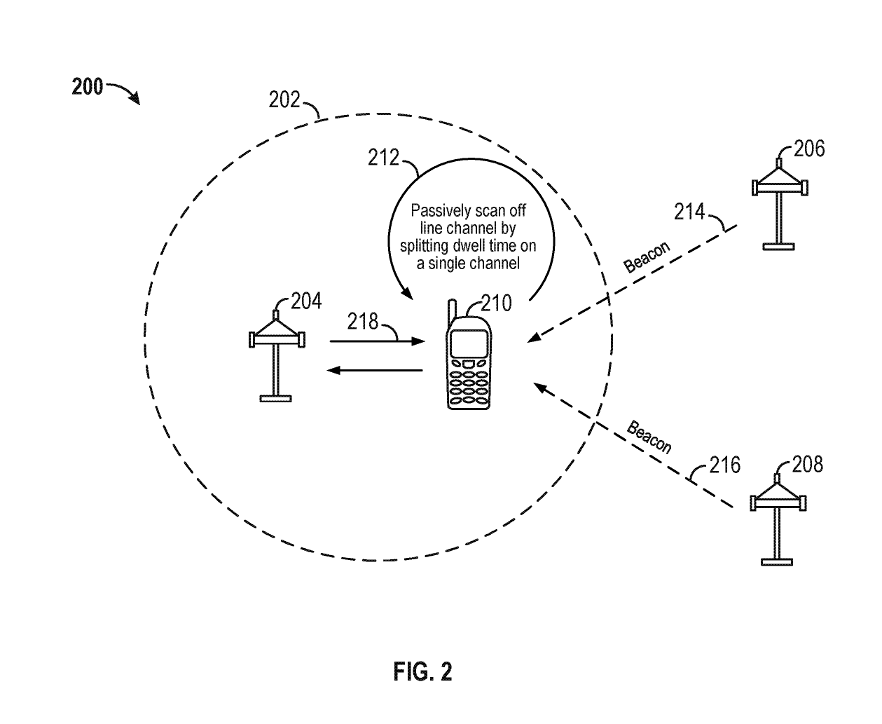

FIG. 2 is an exemplary wireless communication system 200 in which passive scan dwell time on a single channel may be split to reduce the impact of off channel scanning on receiving data packets associated with delay sensitive traffic (e.g., voice or video traffic). The wireless communication system 200 may operate pursuant to a wireless standard, for example the IEEE 802.11 standard. The wireless communication system 200 may include a STA 210 and APs 204, 206, and 208. The STA 210 may receive packets from the AP 204 on channel 218, while passively scanning for beacons from the APs 206 and 208 on channels 214 and 216, respectively.

The AP 204 may act as a base station and provide wireless communication coverage for a BSA 202. The AP 204 along with the STAs associated with the AP 204 and that use the AP 204 for communication (e.g., the STA 210) may be referred to as a BSS. Because the STA 210 may not use the APs 206 and 208 for communication, the APs 206 and 208 may be referred to as non-BSS APs for the STA 210, and the channels on which the APs 206 and 208 transmit beacons may be referred to as non-BSS channels or off line channels for the STA 210. The channel 218 may be referred to as home channel for the STA 210.

Delay sensitive traffic, such as voice traffic and video traffic, may experience gaps in the audio or freezes in the video if data packets are delayed too much before being processed. Therefore, in order to provide satisfactory user experience, it may be desirable to keep the delay times for each type of traffic within a certain boundary so that the delay may not be noticeable to a user. Because the passive scan dwell time on a single channel may be long (e.g., 110 ms), the delay time caused by passively scan an off line channel may cause noticeable delay to a user, thus detrimentally impact user experience.

In one configuration, in order to reduce the impact of off channel scanning on delay sensitive traffic (e.g., voice and/or video), the STA 210 may passively scan (at 212) at least one off line channel (e.g., 214 and/or 216) by splitting dwell time on the channel. The passive scan dwell time for a single channel may be long, e.g., 110 ms. By splitting the passive scan dwell time for a single channel into smaller scan periods (e.g., less than 40 ms), the STA 210 may passively scan the off line channel 214 for 40 ms, then process/receive the delay sensitive traffic associated with the AP 204, then passively scan the off line channel 214 for another 40 ms, and so on. Instead of the delay sensitive traffic being interrupted for the entire passive scan dwell time (e.g., 110 ms), the delay sensitive traffic may be interrupted for shorter time periods (e.g., 40 ms) at a time. As a result, the impact of passively scanning off line channels may be reduced for delay sensitive traffic.

In one configuration, the STA 210 may passively scan the off line channel 214 for 40 ms, then switch back to the home channel 218 to process packets, then passively scan the off line channel 216 for 40 ms before the passive scan for the off line channel 214 is completed (e.g., before the aggregate passive scans for the channel 214 exceeds the passive scan dwell time for a single channel). Thus, the STA 210 may passively scan multiple off line channels concurrently by using time multiplexing, while reducing impact of off channel scanning on delay sensitive traffic.

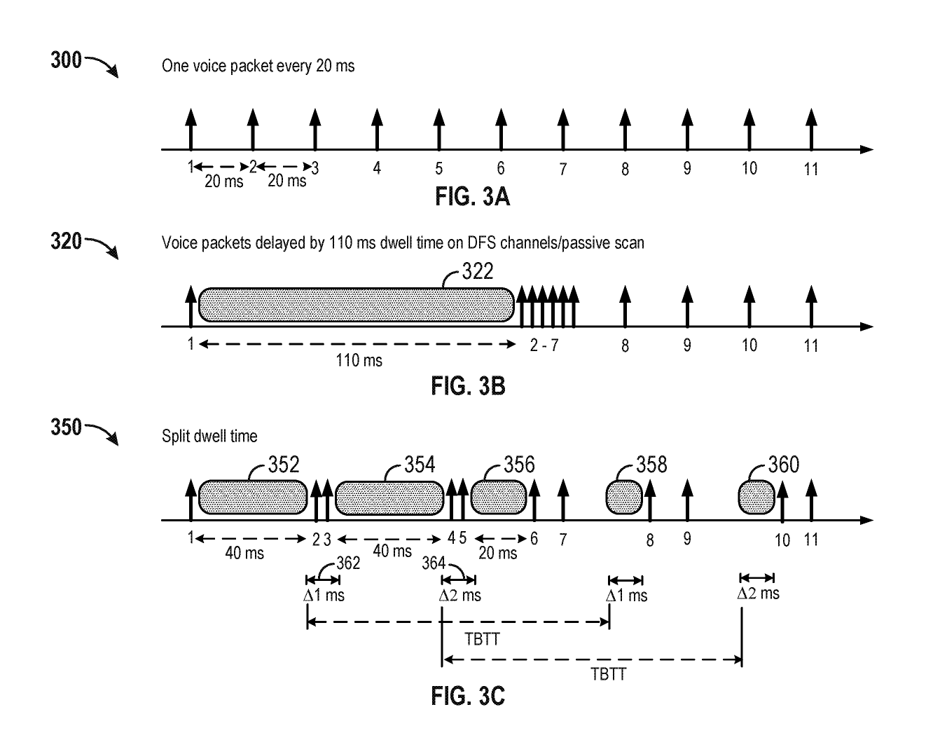

FIG. 3A is a diagram 300 illustrating an example of receiving delay sensitive traffic at a fixed interval of time. In the example, the delay sensitive traffic may be a voice traffic. The voice traffic may have a data packet transmitted every 20 ms and the data packets may be received and processed every 20 ms to avoid gaps in the voice call.

FIG. 3B is a diagram 320 illustrating an example of delay sensitive traffic being impacted by a passive scan of DFS channels. In the example, after receiving voice packet 1 at the home channel, the STA may tune away from the home channel to passively scan (at 322) an off line channel. Because the passive scan dwell time on a single channel may be long (e.g., 110 ms), reception and processing of voice packets 2-7 may be delayed for a long period of time (e.g., as long as 110 ms for packet 2). Thus, the delay in receiving and processing voice packets 2-7 may impact user experience, e.g., by causing gaps or lost portions of a voice call or interruptions in the voice call.

FIG. 3C is a diagram 350 illustrating an example of splitting passive scan dwell time to reduce the impact of off channel scanning on delay sensitive traffic. In the example, the passive scan dwell time on a single channel (e.g., 110 ms) may be divided into several contiguous mini scans (e.g., 352, 354, 356, 358, and 360) spaced apart in time on the channel. Voice packets may be received/processed interspersed with the mini scans. For example, data packets may be received/processed in the time intervals between the mini scans, but not during each mini scan. In one configuration, the duration of each mini scan may be shorter than the beacon transmission interval (e.g., TBTT).

For example, after voice packet 1 is received at the home channel, the STA may tune away from the home channel to perform mini scan 352 (e.g., for 40 ms) on an off line channel. The STA may then switch back to the home channel to receive (at split 362) voice packets 2 and 3 (e.g., for a time interval of Δ₁ ms). In one configuration, the time interval of Δ₁ ms may be determined by the time that may be needed to process buffered voice packets (e.g., the voice packets 2 and 3). The STA may then tune away from the home channel to perform mini scan 354 (e.g., for 40 ms) on the off line channel. The STA may then switch back to the home channel to receive (at split 364) voice packets 4 and 5 (e.g., for a time interval of Δ₂ ms). In one configuration, the time interval of Δ₂ ms may be determined by the time that may be needed to process buffered voice packets (e.g., the voice packets 4 and 5). The STA may then tune away from the home channel to perform mini scan 356 (e.g., for 20 ms) on the off line channel. The STA may then switch back to the home channel to receive voice packets 6 and 7.

The mini scans 358 and 360 may be performed to detect beacons that may be missed when the STA switch back to home channel (e.g., at splits 362 and 364) in the midst of passive scan dwell time to service traffic. For example, if a beacon is transmitted on the off line channel when the STA switches back to the home channel to process the voice packets 2 and 3 at split 362, the STA may miss the opportunity to detect the beacon. Thus, the mini scans 358 and 360 may be timed about 1 TBTT (e.g., 102 ms) away from the corresponding split in dwell duration and may have the same time duration as the corresponding split. So that the STA may miss a beacon during the splits 362 or 364, but may be able to detect a subsequent beacon transmitted on the channel during the mini scans 358 and 360. For example, the mini scan 358 may be 1 TBTT away from the split 362 and have a duration of Δ₁ ms, and the mini scan 360 may be 1 TBTT away from the split 365 and have a duration of Δ₂ ms. In one configuration, some buffer may be added on either side of a mini scan (e.g., 352, 354, 356, 358, or 360) to accommodate clock drifts of the AP.

In one configuration, the method of splitting dwell time on a single channel may be applied to any technology that requires tuning away to an off line channel while there is ongoing delay sensitive traffic on the home channel. In one configuration, the method described above with reference to FIG. 3C may be performed by STA 114 or 210.

In one configuration, off line channel scans may be initiated after a packet is received/processed. This may reduce the number of packets delayed during a scan by one packet compared to starting a scan just before a packet is received/processed. For example, if the passive scan dwell time is 110 ms, depending on whether the off line channel passive scan starts just after or just before a voice packet is received/processed, 6 or 5 packets may be delayed, respectively. Similarly, active scans may be timed to reduce the number of delayed packets by one packet.

In one configuration, the maximum duration of a mini scan may be based on traffic type (e.g. a traffic type with one frame/packet every 20 ms, etc.), de jitter buffer size (e.g. 40 or 60 ms) etc. For example, for voice frames/packets transmitted every 20 ms and a de-jitter buffer of 60 ms, inter-packet delays of 40 ms may be handled by the de-jitter buffer such that the delay introduced by performing a scan that is 40 ms may not impact the user/application experience. De-jitter buffers may be used to counter jitter introduced by queuing in packet switched networks so that a continuous playout of audio (or video) transmitted over the network can be ensured. The maximum jitter that may be countered by a de-jitter buffer may be equal to the buffering delay introduced before starting the play-out of the media stream.

In one configuration, the duration of a mini scan may be based on scan priority (e.g. a priority as initiated by scan client). For example, high priority scans may result in fewer splits (e.g., a longer duration for each mini scan). Hence high priority scans may provide faster scan results, but at the cost of a lower service quality (e.g., increased gaps in voice call or momentary video freezes).

In one configuration, a lookup table (and/or dynamic calculation) may be used to obtain the duration of a mini scan. In one configuration, the duration of a mini scan may be based on one or more of traffic access category (voice, video, etc.), scan priority, frame/packet periodicity, throughput requirements, or de jitter buffer size of the service. For example, because video packets may be more frequent than voice packets, the duration of a mini scan may be shorter for video traffic than for voice traffic. In another example, if the multimedia capability for the STA is higher, the duration of a mini scan may be longer. In one configuration, the duration of a mini scan may be shorter if the throughput requirement is higher. In one configuration, the maximum duration of a mini scan may be longer if the de-jitter buffer size is larger, and the maximum duration of a mini scan may be shorter if the de jitter buffer size is smaller. In one configuration, the passive scan management component may be aware of the traffic type (voice, video, best effort, etc.), e.g., through an existing application programming interface (API).

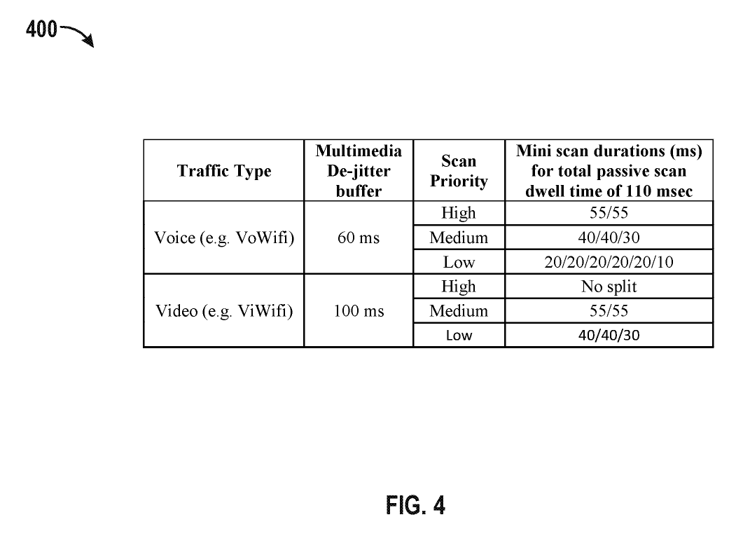

FIG. 4 shows an exemplary lookup table 400 that may be used to obtain mini scan durations based on traffic type, de-jitter buffer size, and scan priority. For example, when the traffic is voice traffic and the size of the multimedia de jitter buffer is 60 ms, the passive scan dwell time 110 ms may be split into two mini scans of 55 ms and 55 ms if the scan priority is high, or the passive scan dwell time 110 ms may be split into three mini scans of 40 ms, 40 ms, and 30 ms if the scan priority is medium, or the passive scan dwell time 110 ms may be split into six mini scans of 20 ms, 20 ms, 20 ms, 20 ms, 20 ms, and 10 ms if the scan priority is low.

In another example, when the traffic is video traffic and the size of the multimedia de-jitter buffer is 100 ms, the passive scan dwell time 110 ms may not be split if the scan priority is high, or the passive scan dwell time 110 ms may be split into two mini scans of 55 ms and 55 ms if the scan priority is medium, or the passive scan dwell time 110 ms may be split into three mini scans of 40 ms, 40 ms, and 30 ms if the scan priority is low.

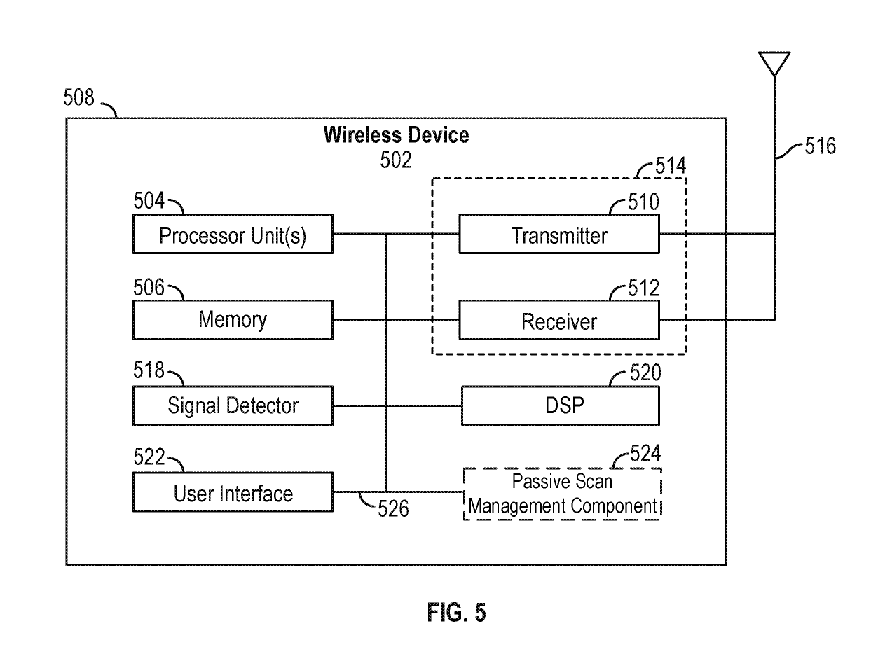

FIG. 5 shows an example functional block diagram of a wireless device 502 that may split passive scan dwell time within the wireless communication system 100 of FIG. 1. The wireless device 502 is an example of a device that may be configured to implement the various methods described herein. For example, the wireless device 502 may be one of the STAs 114, 210.

The wireless device 502 may include a processor 504, which controls operation of the wireless device 502. The processor 504 may also be referred to as a central processing unit (CPU). Memory 506, which may include both read-only memory (ROM) and random access memory (RAM), may provide instructions and data to the processor 504. A portion of the memory 506 may also include non-volatile random access memory (NVRAM). The processor 504 typically performs logical and arithmetic operations based on program instructions stored within the memory 506. The instructions in the memory 506 may be executable (by the processor 504, for example) to implement the methods described herein.

The processor 504 may include or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include a machine-readable medium for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 502 may also include a housing 508, and the wireless device 502 that may include a transmitter 510 and/or a receiver 512 to allow transmission and reception of data between the wireless device 502 and a remote device. The transmitter 510 and the receiver 512 may be combined into a transceiver 514. An antenna 516 may be attached to the housing 508 and electrically coupled to the transceiver 514. The wireless device 502 may also include multiple transmitters, multiple receivers, multiple transceivers, and/or multiple antennas.

The wireless device 502 may also include a signal detector 518 that may be used to detect and quantify the level of signals received by the transceiver 514 or the receiver 512. The signal detector 518 may detect such signals as total energy, energy per subcarrier per symbol, power spectral density, and other signals. The wireless device 502 may also include a DSP 520 for use in processing signals. The DSP 520 may be configured to generate a packet for transmission. In some aspects, the packet may include a physical layer convergence procedure (PLCP) protocol data unit (PPDU).

In some aspects, the wireless device 502 may further include a user interface 522. The user interface 522 may include a keypad, a microphone, a speaker, and/or a display. The user interface 522 may include any element or component that conveys information to a user of the wireless device 502 and/or receives input from the user.

When the wireless device 502 is implemented as a STA (e.g., the STA 114), the wireless device 502 may also include a passive scan management component 524. The passive scan management component 524 may be configured to perform each of the functions and/or steps recited in disclosure with respect to FIGS. 1-3.

The various components of the wireless device 502 may be coupled together by a bus system 526. The bus system 526 may include a data bus, for example, as well as a power bus, a control signal bus, and a status signal bus in addition to the data bus. Components of the wireless device 502 may be coupled together or accept or provide inputs to each other using some other mechanism.

Although a number of separate components are illustrated in FIG. 5, one or more of the components may be combined or commonly implemented. For example, the processor 504 may be used to implement not only the functionality described above with respect to the processor 504, but also to implement the functionality described above with respect to the signal detector 518, the DSP 520, the user interface 522, and/or the passive scan management component 524. Further, each of the components illustrated in FIG. 5 may be implemented using a plurality of separate elements.

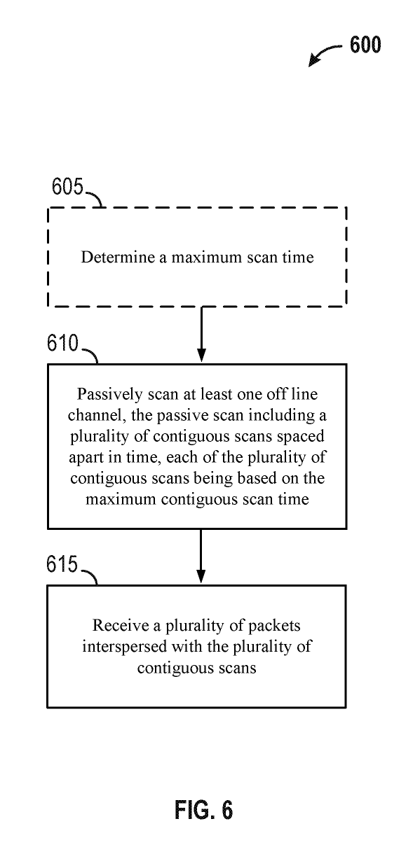

FIG. 6 is a flowchart of an exemplary method 600 for splitting a passive scan dwell time into a plurality of mini scans to reduce the impact of off channel scanning on delay sensitive traffic. The method 600 may be performed using an apparatus (e.g., the STA 114 or 210). Although the method 600 is described below with respect to the elements of wireless device 502 of FIG. 5, other components may be used to implement one or more of the steps described herein.

At 605, the apparatus may optionally determine a maximum scan time. In one configuration, the maximum scan time may be determined based on the size of the de-jitter buffer receiving the plurality of packets. In one configuration, the maximum scan time may be determined based on the priority of the passive scan of the off line channel. In one configuration, the maximum scan time may be determined based on at least one of the traffic access category, the frame periodicity, or the throughput requirements associated with the packets. In one configuration, the maximum scan time may be shorter than the beacon transmission interval (e.g., TBTT).

At 610, the apparatus may passively scan at least one off line channel. The passive scan may include a plurality of contiguous scans spaced apart in time (e.g., mini scans 352, 354, 356, 358, and 360). Each of the plurality of contiguous scans may be based on the maximum scan time. For example and in one configuration, each of the plurality of contiguous scans may not exceed the maximum scan time. In one configuration, the plurality of contiguous scans may be variable in time, but each is less than or equal to the maximum scan time. In one configuration, the passive scan may include a gap period between two of the plurality of contiguous scans, and the time between the gap period and another scan of the plurality of contiguous scans may be equal to a beacon transmission interval. In one configuration, the at least one off line channel may include a DFS channel.

In one configuration, the at least one off line channel may include a first off line channel and a second off line channel. In such a configuration, the plurality of contiguous scans may include a first set of scans for the first off line channel and a second set of scans for the second off line channel. The first set of scans may be interspersed with the second set of scans.

At 615, the apparatus may receive a plurality of packets interspersed with the plurality of contiguous scans (e.g., in time intervals between the plurality of contiguous scans). In one configuration, at least one scan of the plurality of contiguous scans may be based on clock drifts of a remote apparatus (e.g., an AP) transmitting the plurality of packets. For example, some buffers may be added on either side of the at least one scan to accommodate clock drifts of an AP. In one configuration, the plurality of packets may include delay sensitive traffic. In one configuration, the delay sensitive traffic may include voice traffic (e.g., a voice call or VoIP) or video traffic (e.g., a multimedia video stream). In one configuration, the apparatus may tune to home channel to receive the plurality of packets during the intervals between the plurality of contiguous scans, and then tune away from the home channel to the off line channel to perform each scan of the plurality of contiguous scans.

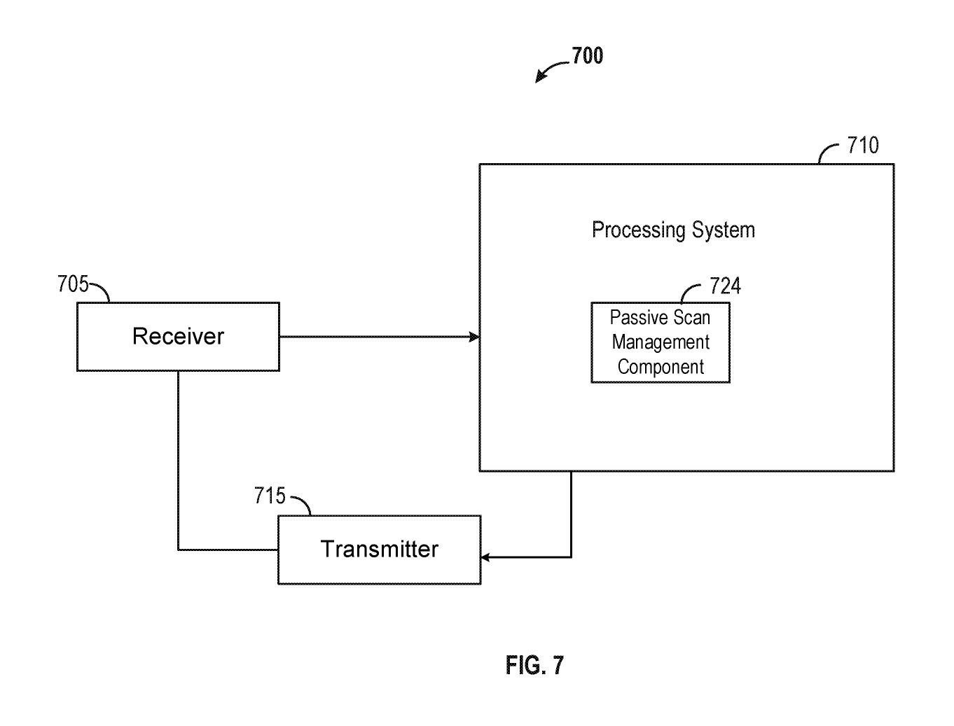

FIG. 7 is a functional block diagram of an example wireless communication device 700 that may split passive scan dwell time to reduce the impact of off channel scanning on delay sensitive traffic. The wireless communication device 700 may include a receiver 705, a processing system 710, and a transmitter 715. The processing system 710 may include a passive scan management component 724.

The receiver 705, the processing system 710, the passive scan management component 724, and/or the transmitter 715 may be configured to perform one or more functions discussed above with respect to FIGS. 1-6. The receiver 705 may correspond to the receiver 512. The processing system 710 may correspond to the processor 504. The transmitter 715 may correspond to the transmitter 510. The passive scan management component 724 may correspond to the passive scan management component 124, and/or the passive scan management component 524.

In one configuration, the wireless communication device 700 may include means for passively scanning at least one off line channel. In one configuration, the means for passively scanning at least one off line channel may perform operations describe above with reference to 610 in FIG. 6. In one configuration, the means for passively scanning at least one off line channel may be the passive scan management component 524, 724, the processor unit(s) 504, or the processing system 710.

In one configuration, the wireless communication device 700 may include means for receiving a plurality of packets interspersed with the plurality of contiguous scans. In one configuration, the means for receiving a plurality of packets interspersed with the plurality of contiguous scans may perform operations describe above with reference to 615 in FIG. 6. In one configuration, the means for receiving a plurality of packets interspersed with the plurality of contiguous scans may be the receiver 512 or 705, the processor unit(s) 504, or the processing system 710.

In one configuration, the wireless communication device 700 may include means for determining a maximum scan time. In one configuration, the means for determining a maximum scan time may perform operations describe above with reference to 605 in FIG. 6. In one configuration, the means for determining a maximum scan time may be the passive scan management component 524, 724, the processor unit(s) 504, or the processing system 710.

The various operations of methods described above may be performed by any suitable means capable of performing the operations, such as various hardware and/or software component(s), circuits, and/or component(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable medium includes both computer storage media and communication media including any medium that facilitates transfer of a computer program from one place to another. A storage media may be any available media that can be accessed by a computer. By way of example, and not limitation, such computer-readable medium can include RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium includes a non-transitory computer readable medium (e.g., tangible media).

The methods disclosed herein include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may include a computer program product for performing the operations presented herein. For example, such a computer program product may include a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein may be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method of wireless communication, comprising:
passively scanning at least one off line channel, wherein the passively scanning comprises a plurality of contiguous scans spaced apart in time; and
receiving a plurality of packets interspersed with the plurality of contiguous scans.

2. The method of claim 1, further comprising:
determining a maximum scan time, wherein each of the plurality of contiguous scans is based on the maximum scan time.

3. The method of claim 2, wherein each of the plurality of contiguous scans does not exceed the maximum scan time.

4. The method of claim 2, wherein the maximum scan time is determined based on a size of a de jitter buffer receiving the plurality of packets.

5. The method of claim 2, wherein the maximum scan time is determined based on a priority of the passively scanning of the at least one off line channel.

6. The method of claim 2, wherein the maximum scan time is determined based on at least one of a traffic access category, a frame periodicity, or throughput requirements associated with the plurality of packets.

7. The method of claim 2, wherein the passively scanning includes a gap period between two of the plurality of contiguous scans, and wherein a time between the gap period and another one of the plurality of contiguous scans is equal to a beacon transmission interval.

8. The method of claim 2, wherein at least one of the plurality of contiguous scans is based on clock drifts of a remote apparatus transmitting the plurality of packets.

9. The method of claim 1, wherein the plurality of packets comprise delay sensitive traffic, wherein the delay sensitive traffic comprises voice or video.

10. The method of claim 1, wherein the at least one off line channel comprises a dynamic frequency selection (DFS) channel.

11. The method of claim 1, wherein the at least one off line channel comprises a first off line channel and a second off line channel, wherein the plurality of contiguous scans comprises a first set of scans for the first off line channel and a second set of scans for the second off line channel, wherein the first set of scans is interspersed with the second set of scans.

12. An apparatus for wireless communication, comprising:
means for passively scanning at least one off line channel, wherein the passively scanning comprises a plurality of contiguous scans spaced apart in time; and
means for receiving a plurality of packets interspersed with the plurality of contiguous scans.

13. The apparatus of claim 12, further comprising:
means for determining a maximum scan time, wherein each of the plurality of contiguous scans is based on the maximum scan time.

14. The apparatus of claim 13, wherein each of the plurality of contiguous scans does not exceed the maximum scan time.

15. The apparatus of claim 13, wherein the maximum scan time is determined based on a size of a de jitter buffer receiving the plurality of packets.

16. The apparatus of claim 13, wherein the maximum scan time is determined based on a priority of the passively scanning of the at least one off line channel.

17. The apparatus of claim 13, wherein the maximum scan time is determined based on at least one of a traffic access category, a frame periodicity, or throughput requirements associated with the plurality of packets.

18. The apparatus of claim 13, wherein the passively scanning includes a gap period between two of the plurality of contiguous scans, and wherein a time between the gap period and another one of the plurality of contiguous scans is equal to a beacon transmission interval.

19. The apparatus of claim 13, wherein at least one of the plurality of contiguous scans is based on clock drifts of a remote apparatus transmitting the plurality of packets.

20. The apparatus of claim 12, wherein the plurality of packets comprise delay sensitive traffic, wherein the delay sensitive traffic comprises voice or video.

21. The apparatus of claim 12, wherein the at least one off line channel comprises a dynamic frequency selection (DFS) channel.

22. An apparatus for wireless communication, comprising:
a memory; and
at least one processor coupled with the memory and configured to:
passively scan at least one off line channel, wherein the passively scanning comprises a plurality of contiguous scans spaced apart in time; and
receive a plurality of packets interspersed with the plurality of contiguous scans.

23. The apparatus of claim 22, wherein the at least one processor is further configured to:
determine a maximum scan time, wherein each of the plurality of contiguous scans is based on the maximum scan time.

24. The apparatus of claim 23, wherein each of the plurality of contiguous scans does not exceed the maximum scan time.

25. The apparatus of claim 23, wherein the maximum scan time is determined based on a size of a de jitter buffer receiving the plurality of packets.

26. The apparatus of claim 23, wherein the maximum scan time is determined based on a priority of the passively scanning of the at least one off line channel.

27. The apparatus of claim 23, wherein the maximum scan time is determined based on at least one of a traffic access category, a frame periodicity, or throughput requirements associated with the plurality of packets.

28. The apparatus of claim 23, wherein the passively scanning includes a gap period between two of the plurality of contiguous scans, and wherein a time between the gap period and another one of the plurality of contiguous scans is equal to a beacon transmission interval.

29. The apparatus of claim 23, wherein at least one of the plurality of contiguous scans is based on clock drifts of a remote apparatus transmitting the plurality of packets.

30. A computer-readable medium of a wireless device storing computer executable code, comprising code to:
passively scan at least one off line channel, wherein the passively scanning comprises a plurality of contiguous scans spaced apart in time; and
receive a plurality of packets interspersed with the plurality of contiguous scans.
